(19) United States
(12) Patent Application Publication
(10) Pub. No.: US 2013/0290549 A1
(43) Pub. Date: Oct. 31, 2013

(54) METHOD FOR MANAGING NETWORK CONNECTION INFORMATION AND ELECTRONIC DEVICE THEREOF

(71) Applicant: SAMSUNG ELECTRONICS CO. LTD., Suwon-si (KR)

(72) Inventors: Hong-Rae CHO, Bucheon-si (KR); Yong-Sik KIM, Yongin-si (KR)

(73) Assignee: Samsung Electronics Co. Ltd., Suwon-si (KR)

(21) Appl. No.: 13/870,446

(22) Filed: Apr. 25, 2013

(30) Foreign Application Priority Data
Apr. 26, 2012 (KR) 10-2012-0043814

(51) Int. Cl. H04L 29/06

(52) U.S. Cl. CPC H04L 65/1069
USPC 709/228

(57) ABSTRACT

An electronic device capable of connecting to networks, and in particular, to a device and method for managing Packet Data Protocol (PDP) context in an electronic device are provided. The method includes when first network connection information stored in a memory upon performance of an initialization booting operation is different from second network connection information, using the second network connection information for network connection, wherein the first network connection information corresponds to network connection information defined by default in the electronic device and the second network connection information corresponds to network connection information updated by a service provider.

### PRIORITY

This application claims the benefit under 35 U.S.C. §119 of a Korean patent application filed on Apr. 26, 2012 in the Korean Intellectual Property Office and assigned Serial No. 10-2012-0043814, the entire disclosure of which is hereby incorporated by reference.

### BACKGROUND OF THE INVENTION

1. Field of the Invention

The present invention relates to an electronic device capable of connecting to networks. More particularly, the present invention relates to an electronic device capable of using network connection information updated by a service provider even after initialization of the electronic device.

2. Description of the Related Art

Generally, in order to use a packet service in a General Packet Radio Service (GPRS)/Wideband Code Division Multiple Access (WCDMA) network, a mobile station connects to a network to transmit and receive packets through Packet Data Protocol (PDP) context activation. After connection to the network, the mobile station transmits and receives data using a protocol, such as Transmission Control Protocol/Internet Protocol (TCP/IP).

The PDP context is generally defined by default in the mobile station, and may be updated by a service provider.

As an example, when the service provider updates an Access Point Name (APN), information about the updated APN is provided to the mobile station. Thereafter, the mobile station updates APN information and can connect to a network by using the updated APN information.

However, when the mobile station is initialized, the updated APN information is deleted.

Thus, the initialized mobile station may attempt to connect to a network using a default APN. Because the service provider has updated the APN of the network, the mobile station is unable to connect to the network by using the default APN.

As a result, the mobile station should receive APN information updated by the service provider and update the default APN before connection to the network.

Therefore, a need exists for a device and method for being capable of using network connection information updated by a service provider even after initialization of an electronic device.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages below. Accordingly, an aspect of the present invention is to provide a device and method for being capable of using network connection information updated by a service provider even after initialization of an electronic device.

Another aspect of the present invention is to provide a device and method for backing up updated network connection information into a nonvolatile memory area in an electronic device.

Another aspect of the present invention is to provide a device and method for loading backed up network connection information and using the network connection information for network connection upon initialization booting in an electronic device.

In accordance with an aspect of the present invention, a method for managing network connection information in an electronic device is provided. The method includes, when first network connection information stored in a memory upon performance of an initialization booting operation is different from second network connection information, using the second network connection information for network connection, wherein the first network connection information corresponds to network connection information defined by default in the electronic device and the second network connection information corresponds to network connection information updated by a service provider.

In accordance with another aspect of the present invention, a device for managing network connection information in an electronic device is provided. The device includes at least one processor, a memory, and at least one module stored in the memory and configured to be executable by the processor, wherein the module includes an instruction for, when first network connection information stored in the memory upon performance of an initialization booting operation is different from second network connection information, using the second network connection information for network connection, wherein the first network connection information corresponds to network connection information defined by default in the electronic device and the second network connection information corresponds to network connection information updated by a service provider.

In accordance with yet another aspect of the present invention, a non-transient computer-readable recording medium stores one or more programs is provided. The medium includes instructions for causing, when executed in an electronic apparatus, the electronic apparatus to perform a method for, when first network connection information stored in a memory upon performance of an initialization booting operation is different from second network connection information, using the second network connection information for network connection.

In accordance with still another aspect of the present invention, an electronic device capable of connecting to a network is provided. The device includes at least one processor, a memory, and at least one module stored in the memory and configured to be executable by the processor, wherein the module includes an instruction for, when Access Point Name (APN) information is updated, storing the updated APN information in a non-volatile memory, and, when an initialization booting operation is performed, performing connection to a network using the updated APN information stored in the nonvolatile memory.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings in which:

FIG. 1 is a block diagram illustrating a configuration of an electronic device for managing network connection information according to an exemplary embodiment of the present invention;

FIGS. 2A to 2C are diagrams illustrating a process for managing network connection information in an electronic device according to an exemplary embodiment of the present invention;

FIGS. 3A to 3C are diagrams illustrating a process for managing network connection information in an electronic device according to an exemplary embodiment of the present invention;

FIG. 4 is a diagram illustrating a process for backing up network connection information in an electronic device according to an exemplary embodiment of the present invention;

FIG. 5 is a diagram illustrating a process for restoring network connection information in an electronic device according to an exemplary embodiment of the present invention; and

FIGS. 6 and 7 are block diagrams illustrating operations of a processor for backing up network connection information according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and configurations may be omitted for clarity and conciseness

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, a device and method for managing network connection information used for network connection in an electronic device according to exemplary embodiments of the present invention will be described. In this case, the electronic device backs up network connection information updated by a service provider, and, when initialization booting is performed, uses the backed up network connection information.

According to exemplary embodiments of the present invention, the network connection information may be Packet Data Protocol (PDP) context, such as an Access Point Name (APN), authentication information, a user name, or the like.

According to exemplary embodiments of the present invention, the electronic device may be a portable electronic device. Examples of a portable electronic device include a portable terminal, a mobile phone, a media player, a tablet computer, a handheld computer, or a Personal Digital Assistant (PDA), and the like. In addition, the electronic device may be an arbitrary portable electronic device including a device into which two or more functions are integrated among the above-described devices.

The initialization booting to be described in the following description corresponds to a booting operation which is initially performed in a state in which only necessary data remains (e.g., is kept) and data other than the necessary data is deleted. The initialization booting may include all other booting operations (e.g., cold (re) booting, warm (re) booting, or the like).

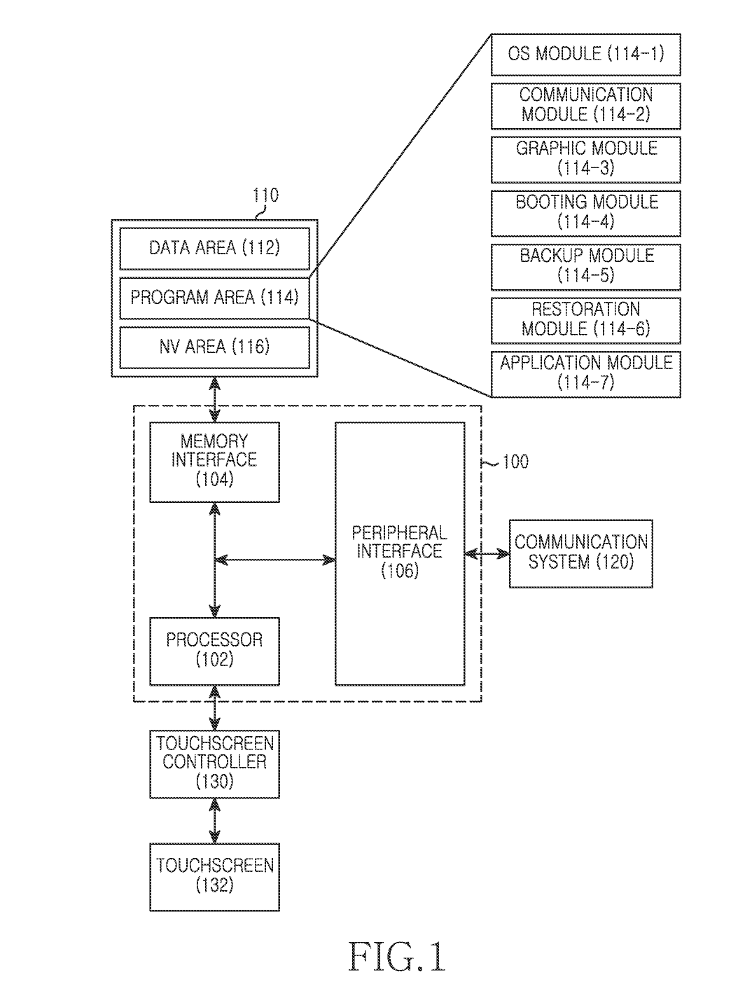

FIG. 1 is a block diagram illustrating a configuration of an electronic device for managing network connection information according to an exemplary embodiment of the present invention.

Referring to FIG. 1, the electronic device includes a processor unit 100, a memory 110, a wireless communication system 120, a touchscreen controller 130, and a touchscreen 132.

The processor unit 100 may include at least one processor 102, a memory interface 104, and a peripheral interface 106. In some cases, the processor unit 100 may also be referred to as a processor. The memory interface 104, the at least one processor 102, and/or the peripheral interface 106 may be integrated into at least one integrated circuit or may be implemented as separate components, and the various elements of the electronic device may be coupled by at least one communication bus (not illustrated) or stream line (not illustrated).

The processor 102 executes various software programs to perform various functions for the electronic device, and performs processes and controls for voice communication and data communication. In addition to these general functions, the processor 102 executes software modules (instruction sets) stored in the memory 110 and performs various functions corresponding to the software modules. For example, the processor 102 performs methods according to of exemplary embodiments of the present invention in cooperation with software modules stored in the memory 110.

According to exemplary embodiments of the present invention, the processor 102 performs a backup process of enabling a backup module 114-5 stored in the memory 110 to store network connection information updated by a service provider in the nonvolatile area 116 of the memory 110. Thereafter, when checking that (e.g., determining whether) the electronic device has been initialized, and the updated network connection information has been deleted, the processor 102 can perform a restoration operation using the network connection information stored in the nonvolatile area 116.

The communication system 120 performs a communication function through one or more wireless communication systems. The communication systems 120 may include a Radio Frequency (RF) receiver and transceiver, an optical (e.g., infrared) receiver and transceiver, and the like.

The communication system 120 may be designed to operate according to communication networks of the electronic device. For example, the communication networks may include, but not limited to, a Global System for Mobile Communication (GSM) network, an Enhanced Data GSM Environment (EDGE) network, a Code Division Multiple Access (CDMA) network, a W-Code Division Multiple Access (W-CDMA) network, a Long Term Evolution (LTE) network, an Orthogonal Frequency Division Multiple Access (OFDMA) network, a Wireless Fidelity (WiFi) network, a WiMax network, and/or a Bluetooth network. According to exemplary embodiments of the present invention, the electronic device may receive network connection information updated by a service provider through the communication system 120.

The touchscreen controller 130 may be connected to the touchscreen 132. The touchscreen 132 and the touchscreen controller 130 may detect a touch, a motion, or a stop thereof by using multi-touch detection technologies including a proximity sensor array or other elements, as well as capacitive, resistive, infrared, surface acoustic wave technologies, and the like for determining one or more touch points.

In addition, the touchscreen 132 provides an I/O interface between the electronic device and the user. For example, the touchscreen 132 transmits a user touch input to the electronic device 100, and is a medium that displays an output from the electronic device to the use. For example, the touchscreen 132 displays a visual output to the user. The visual output may be represented by a text, a graphic, a video, or a combination thereof. For example, the touchscreen 132 may perform the functions of an input unit and a display unit. As an example, the touch screen 132 may transmit a user touch input to the touch screen controller 130 which in turn may transmit the touch input to the processor 102.

The touchscreen 132 may use various display technologies. For example, the touchscreen 1280 may use a Liquid Crystal Display (LCD), a Light Emitting Diode (LED), a Light emitting Polymer Display (LPD), an Organic Light Emitting Diode (OLED), an Active Matrix Organic Light Emitting Diode (AMOLED), a 3D display, a Flexible LED (FLED), and the like.

The memory 110 may be connected to the memory interface 104 of the processor unit 100. The memory unit 110 may include one or more high-speed Random-Access Memories (RAMs) such as magnetic disk storage devices, one more nonvolatile memories, one or more optical storage devices, and/or one or more flash memories (for example, NAND flash memories or NOR flash memories). The memory may include a non-transitory computer-readable storage medium.

Specifically, the memory 110 may be divided into a program area 114 for storing programs for controlling the operations of the electronic device, a data area 112 for storing data generated when the programs are executed, and a nonvolatile area 116 for storing nonvolatile data.

For example, the program area 114 of the memory 110 includes an Operating System (OS) software module 114-1, a communication software module 114-2, a graphic software module 114-3, and at least one application software module 114-7. Because the module that is an element of the software may be represented as a set of instructions, the module may be referred to as an instruction set. The module may also be referred to as a program, and the software module may also be referred to as a module.

In this specification, one or more modules including instructions for performing various methods according to exemplary embodiments of the present invention may be stored in the program area 114 of the memory 110.

The OS module 114-1 includes various software elements for controlling general system operations. For example, general system operation controls include memory control/management, storage hardware (device) control/management, and power control/management. The OS module 114-1 also performs a function for enabling smooth communication between various hardware elements (devices) and software elements (modules).

The communication software module 114-2 includes various software elements for processing data transmission and data reception, and may enable communication with other electronic devices (e.g., computers, servers, portable terminals, and/or the like) such as through the wireless communication or an external port. Although not illustrated in FIG. 1, the external port may be used for connection to other electronic devices directly or indirectly through a network (e.g., Internet, intranet, wireless LAN, and the like). The external port may be, for example, a Universal Serial Bus (USB) port, a FireWire port, and/or the like.

The graphic module 114-3 includes various software elements for providing and displaying graphics on the touchscreen 132. The graphics include texts, web pages, icons, digital images, videos, animations, and the like.

The application module 114-7 includes a browser application, an e-mail application, an instant message application, a word processing application, a keyboard emulation application, an address book application, a touch list application, a widget application, a Digital Right Management (DRM) application, a voice recognition application, a voice replication application, a position determining function application, a Location-Based Service (LBS) application, and the like. The memory 110 may include an additional module (instructions) besides the above-described modules. If necessary, the memory 110 may not use some modules (instructions).

According to an exemplary embodiment of the present invention, the program area 114 of the memory 110 includes a booting module 114-4, a backup module 114-5, and a restoration module 114-6.

The booting module 114-4 performs the booting operation of the electronic device, thereby enabling the electronic device to operate normally through the booting operation. For example, when the electronic device performs an initialization booting operation, the booting module 114-4 loads default network connection information stored in the memory 110 into the internal memory of the processor unit 100, thereby making network connection possible.

The backup module 114-5 stores the network connection information updated by the service provider in the nonvolatile area 106 of the memory.

In addition, when the booting operation is performed through the operation of the booting module 114-4, the restoration module 114-6 can determine whether network connection information has been stored in the nonvolatile area 116 of the memory 110. Thereafter, the restoration module 114-6 loads the network connection information stored in the nonvolatile area 116 into the internal memory of the processor unit 100, thereby making connection to networks possible. Because the network connection information (updated by a service provider), which has been used before initialization, is deleted during the initialization operation, the information stored in the nonvolatile area 116 is restored and used.

In addition, although not illustrated, the program area 114 of the memory 110 may include a user interface module including various software elements related to a user interface. Through the user interface module, the electronic device provides information about how the state of a user interface changes and/or information about under what condition the state of a user interface changes.

In addition, although not illustrated, the program area 114 of the memory 110 may include a codec module including software elements related to video file encoding/decoding. In this case, the codec module includes a video stream module such as an MPEG module and/or an H204 module, and may include various codec modules for audio files, such as AAA, AMR, WMA, and the like.

In addition, although not illustrated, the program area 114 of the memory 110 may include a camera module including camera-related software elements that enable camera-related processes and functions.

In addition, the modules included in the program area 114 of the memory 110 are stored in the nonvolatile area 116 when becoming necessary components for operations of the electronic device, thereby performing fundamental operation even after initialization.

In addition, various functions of the electronic device 100 according to exemplary embodiments the present invention, which have been described above and will be described below, may be implemented by any combination of hardware and/or software including one or more stream processings and/or an Application-Specific Integrated Circuit (ASIC).

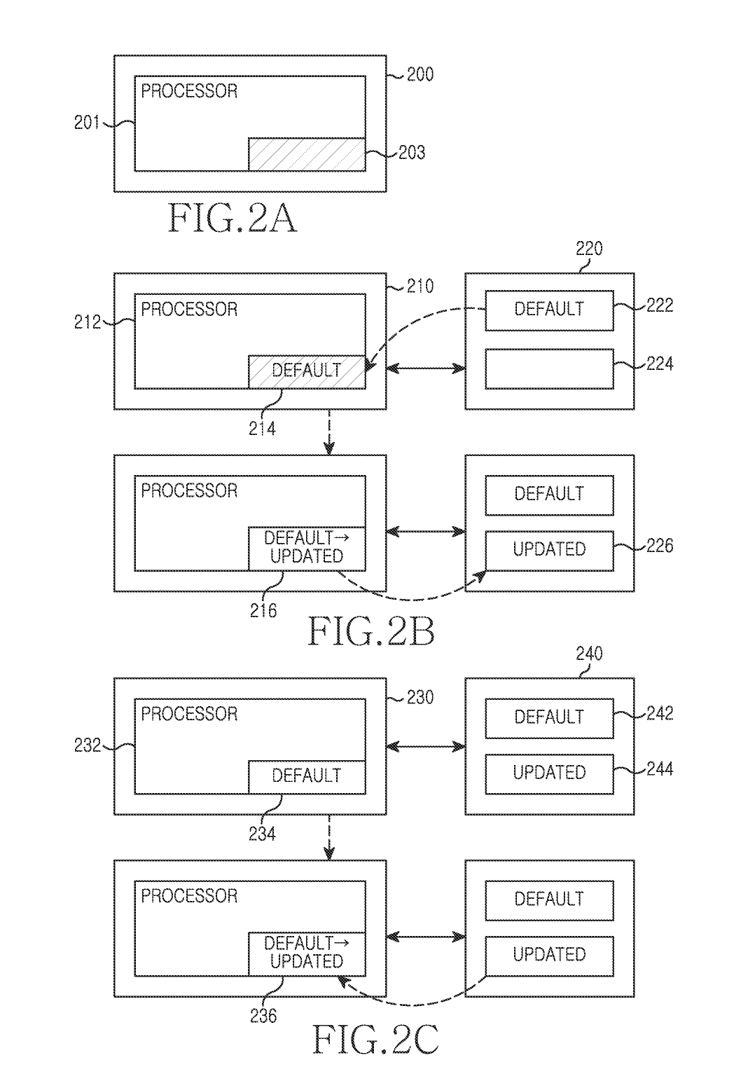

FIGS. 2A to 2C are diagrams illustrating a process for managing network connection information in an electronic device according to an exemplary embodiment of the present invention.

Referring to FIGS. 2A to 2C, the electronic device 200 may include a storage area 203 for storing network connection information in a processor 201, as illustrated FIG. 2A. The network connection information stored in an area 203 is what is obtained by loading default network connection information 224 stored in a memory 220, which is illustrated in FIG. 2B. Therefore, the processor can use the network connection information stored in the area for network connection. In this case, the memory 220 includes the nonvolatile storage area 224, and, therefore, when the network connection information is updated, can store information about the updated information.

According to exemplary embodiments of the present invention, the network connection information may be updated by a service provider. For example, the service provider can update network connection information (e.g., Access Point Name (APN) used by the electronic device through an Over The Air (OTA) message or a Device Management (DM) session, and the like).

As described above, when the network connection information is updated, the electronic device 210 updates the network connection information 214 in the processor 212 according to a user request. For example, the electronic device updates the network connection information stored in area 214 with the network connection information 222 stored in the memory 220. The electronic device 210 uses the updated network connection information 216 for network connection. For example, the electronic device cannot connect to networks using network connection information before updating.

Generally, the network connection information stored in the processor is deleted during an initialization operation. The electronic device loads the default network connection information stored in the memory into the processor at the time of being booted firstly after the initialization.

However, after the network connection information stored in the processor is updated by a service provider, the electronic device may perform an initialization operation. In this case, a problem occurs in which the electronic device loads the default network connection information at the time when the initialization operation is performed, thereby making connection to networks impossible.

In order to resolve the above-described problem, the electronic device according to exemplary embodiments of the present invention performs a backup process of storing the network connection information updated by the service provider in the nonvolatile area 224 of the memory 220. The nonvolatile area 224 of the memory 220 stores the updated network connection information 226.

When the electronic device, which has performed the backup process, performs an initialization booting operation, the electronic device 230 loads the default network connection information 242 into the processor 232 as illustrated in FIG. 2C. Thereafter, the electronic device 230 determines whether the network connection information is backed up into the nonvolatile area 244 of the memory 240. If the network connection information exists in the nonvolatile area 244, the electronic device 230 loads the network connection information 236 into the processor 232 and uses the same for network connection.

In contrast, when the network connection information does not exist in the nonvolatile area, the electronic device can perform a general operation of using the default network connection information 234 loaded into the processor for network connection.

The updated network connection information is stored in the memory. When performing a general booting operation (e.g., cold booting, or warm booting), the electronic device can perform a general operation of loading the updated network connection information 236 into a memory in the processor 232 and using the information for network connection.

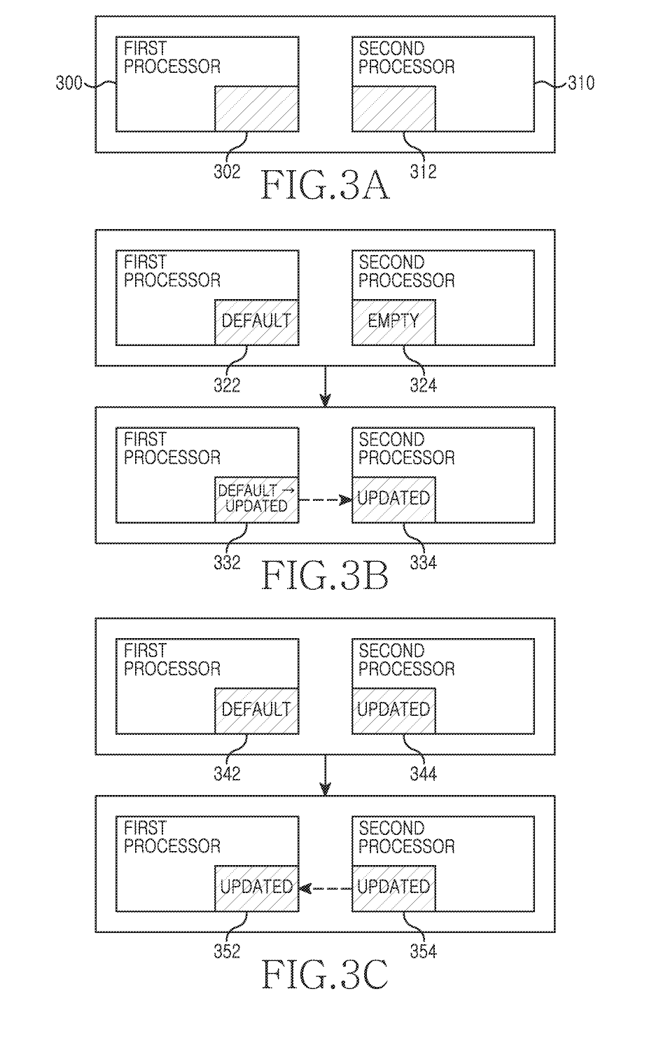

FIGS. 3A to 3C are diagrams illustrating a process for managing network connection information in an electronic device according to an exemplary embodiment of the present invention.

Referring to FIG. 3A, the electronic device includes two processors 300 and 310. Each processor includes storage areas 302 and 312 for storing information necessary for operations of the electronic device, and the network connection information may be stored in the storage area of each processor.

In this case, the first processor 300 may be an Application Processor (AP), and the second processor 310 may be a communication processor.

The storage area 302 of the first processor stores information required for execution of applications, and the information of the storage area 302 is deleted upon initialization of the electronic device. In addition, the network connection information is stored in the storage area 302 of the first processor 300, and may be updated by a service provider.

The storage area 312 of the second processor 310 is an area in which nonvolatile data is stored, and the information of the storage area 312 is not deleted upon initialization of the electronic device. In addition, the storage area 312 of the second processor 310 stores the network connection information updated by the service provider and existing in the storage area 302 of the first processor 300, so that the updated network connection information is not deleted in the electronic device even though the electronic device is initialized.

Referring to FIG. 3B, the electronic device may update the network connection information.

First, the electronic device loads the default network connection information 322 stored in a memory into the storage area of the first processor to enable the default network connection information to be used for network connection. When the network connection information is not updated by a service provider, separate network connection information is not stored in the storage area 324 of the second processor.

If the network connection information is updated by a service provider, the electronic device performs a backup process of updating the network connection information stored 332 in the storage area of the first processor, and storing the updated network connection information 334 in the storage area of the second processor.

Referring to FIG. 3C, the electronic device can restore the network connection information.

First, when being initialized after the network connection information has been updated as illustrated in FIG. 3B, the electronic device loads the default network connection information 342 stored in the memory into the first processor, and uses the default network connection information.

However, because the updated network connection information 344 exists in the storage area of the second processor, the electronic device loads the network connection information 354 stored in the storage area of the second processor into the storage area of the first processor and uses the loaded network connection information 352 for network connection.

In contrast, if the network connection information does not exist in the storage area of the second processor, the electronic device can perform a general operation of using the default network connection information for network connection.

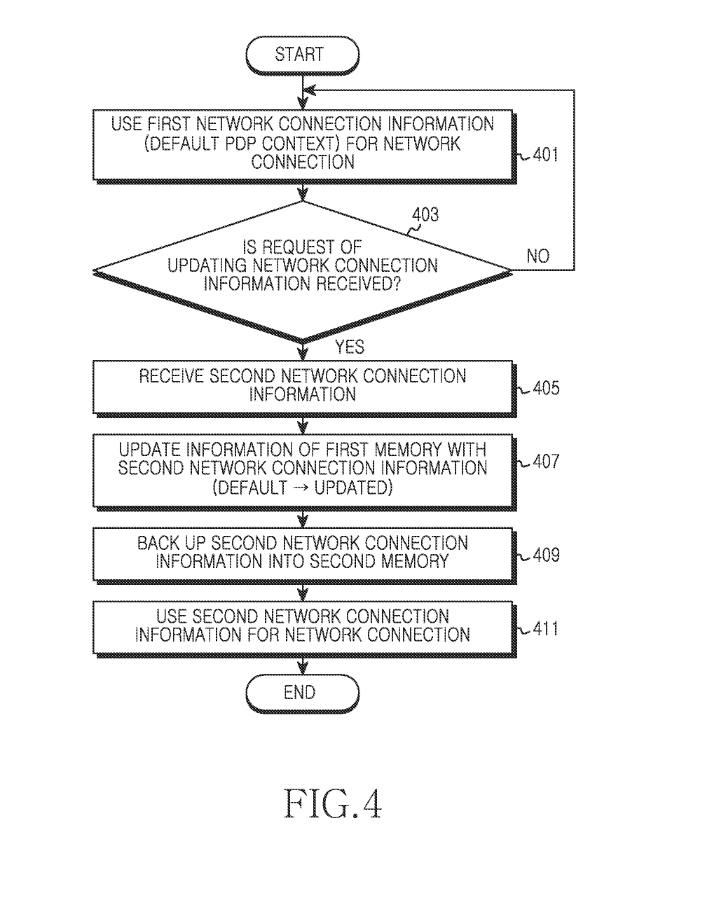

FIG. 4 is a diagram illustrating a process for backing up network connection information in an electronic device according to an exemplary embodiment of the present invention.

Referring to FIG. 4, in step 401, the electronic device firstly uses first network connection information for network connection. In this case, the electronic device stores the network connection information (e.g., PDP context) set by default, which is defined as first network connection information.

Thereafter, in step 403, the electronic device determines whether a request of updating the network connection information is received. In this case, the request of updating the network connection information is a request of updating previously used network connection information through an OTA message or a DM session, for example, a request of updating an Access Point Name (APN) required for network connection.

If the electronic device determines that the request of updating the network connection information has not been received in step 403, the electronic device proceeds to step 401 and uses the previously set network connection information for network connection.

In contrast, if the electronic device determines that the request for requesting updating of the network connection information has been received in step 403, the electronic device proceeds to step 405 and receives second network connection information provided by a service provider. In this case, the second network connection information corresponds to information with which the existing network connection information used by the service provider is updated.

Thereafter, in step 407, the electronic device updates the information of the first memory with the received second network connection information. In step 409, the electronic device stores the second network connection information in the second memory. In this case, the first memory is a storage area into which the network connection information stored by default in order to make connection to networks possible, and, when the network connection information is updated by the service provider, information stored in the first memory is also updated. However, when the electronic device is initialized, the information stored in the first memory is deleted.

In addition, the second memory is a nonvolatile area into which the updated network connection information is backed up, and, even through the electronic device is initialized, the information stored in the second memory is not deleted.

Thereafter, in step 411, the electronic device uses the second network connection information stored in the first memory for network connection. If the network connection information is updated by a service provider during usage of the second network connection information, the electronic device repeatedly performs the above-described operations to perform a process of backing up the updated network connection information into the second memory.

The electronic device, which has backed up the network connection information as described above, ends the algorithm.

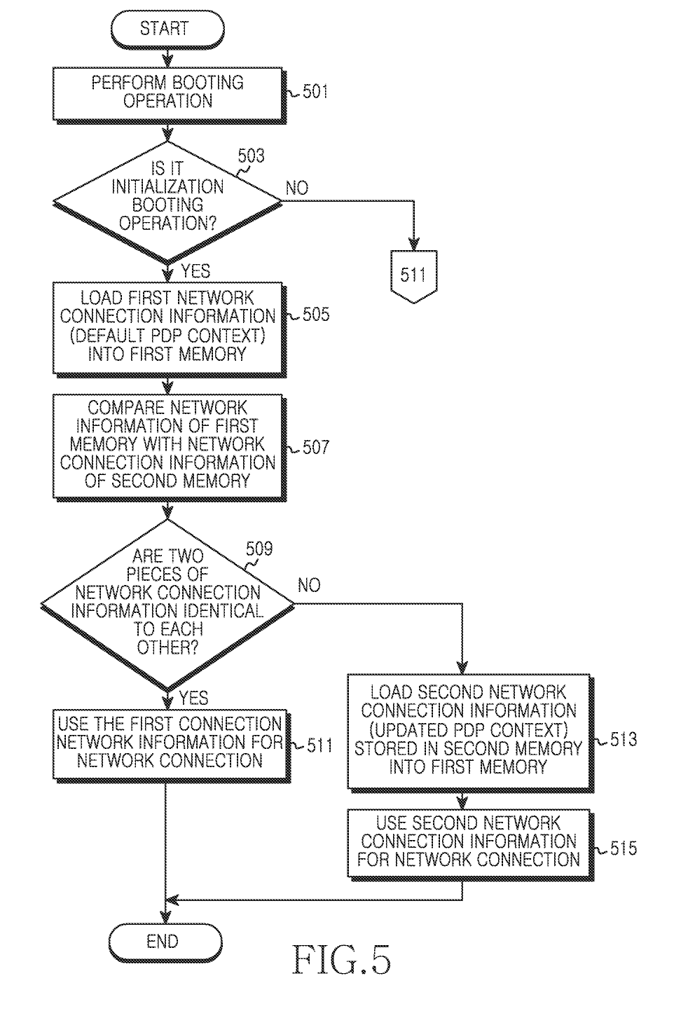

FIG. 5 is a diagram illustrating a process for restoring network connection information in an electronic device according to an exemplary embodiment of the present invention.

Referring to FIG. 5, after performing a booting operation, the electronic device can determine whether an initialization booting operation or a general booting operation is performed using code information provided by an operating system. The initialization booting operation corresponds to a booting operation performed firstly in the state in which only data necessary for configuring the electronic device remains, and the remaining data (e.g., data not necessary for configuring the electronic device) is deleted. Examples of the initialization booting operation may include a situation in which factory initialization of restoring the system area of the memory to its initial state has been performed, and then firstly the electronic device performs a booting operation. The initialization booting corresponds to a booting operation of loading currently existing data to prepare for the operation of the electronic device, and may include all other booting operations (e.g., cold (re) booting, warm (re) booting, or the like).

The network connection information updated by a service provider is deleted and, therefore, does not exist in the electronic device in which the initialization booting operation has been performed, and the network connection information updated by a service provider is not deleted and, therefore, exists in the electronic device in which a general booting operation has been performed.

In step 501, the electronic device performs a booting operation.

After performing a booting operation in step 501, in step 503, the electronic device determines whether an initialization booting operation has been performed.

When the electronic device determines that the general booting operation has been performed in step 503, the electronic device proceeds to step 511 in which the electronic device loads and uses first network connection information for network connection. In this case, the first network connection information is the network connection information provided by default in the electronic device and is not updated by the service provider.

In contrast, when the electronic device determines that the initialization booting operation has been performed in step 503, the electronic device proceeds to step 505 in which the electronic device performs an operation of preparing for operation of the electronic device by loading the first network connection information into the first memory.

Thereafter, in step 507, the electronic device compares network connection information stored in the first memory with network connection information stored in the second memory. The comparison is performed to determine whether the network connection information used in the electronic device before initialization is the network connection information updated by a service provider.

For example, when the initialization booting operation is performed, the electronic device loads the network connection information provided by default into the first memory. In addition, the electronic device backs up the network connection information used recently into the second memory as illustrated in FIG. 4, and compares the network connection information of the first memory with the network connection information of the second memory, thereby determining whether the network connection information is updated by a service provider.

Thereafter, in step 509, the electronic device determines (e.g., checks) the result of the comparison operation of step 507. For example, in step 509, the electronic device determines whether the network connection information (e.g., first network connection information) is identical to the network connection information (e.g., second network connection information).

When the electronic device determines that the two pieces of network connection information of the two memories are identical to each other in step 509, the electronic device proceeds to step 511 in which the electronic device uses the first network connection information (default network connection information) for network connection. The reason for this is that the network connection information used before initialization has not been updated by the service provider.

In contrast, when the electronic device determines that the pieces of network connection information of two memories are not identical to each other in step 509, the electronic device proceeds to step 513 in which the electronic device loads the second network connection information (network connection information updated by the service provider) into the first memory. Thereafter, in step 515, the electronic device uses the second network connection information for network connection.

Thereafter, the electronic device ends the algorithm.

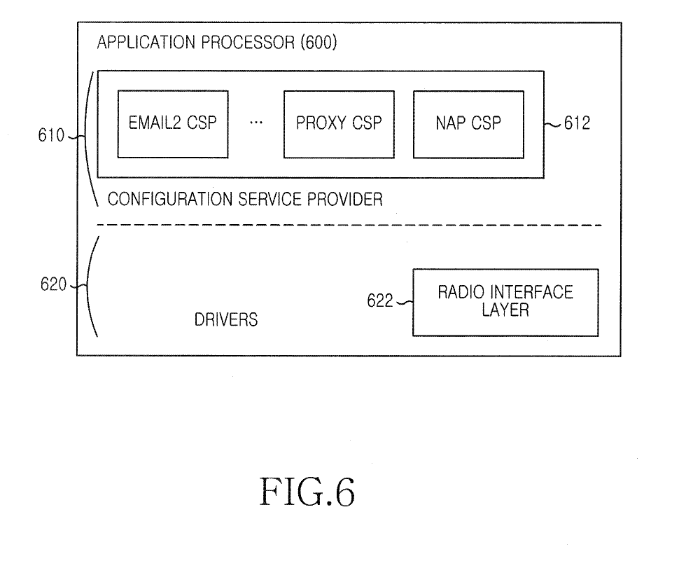

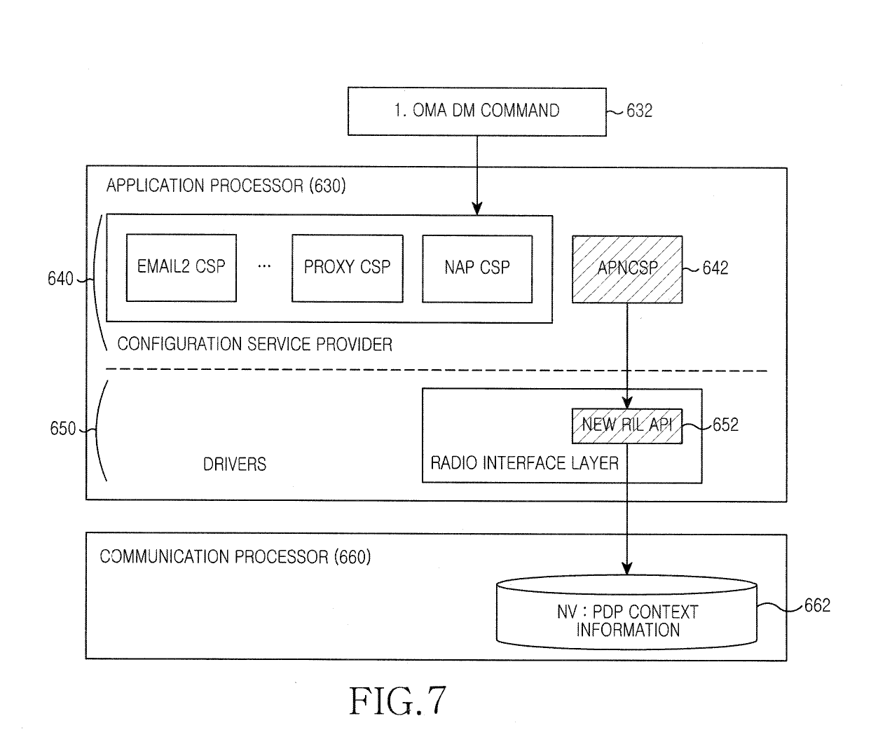

FIGS. 6 and 7 are block diagrams illustrating operations of a processor for backing up network connection information according to an exemplary embodiment of the present invention.

Referring to FIG. 6, the processor (e.g., application processor) 600 includes a plurality of Configuration Service Providers (CSP) 610 and drivers 620.

CSP 612 manages settings for a corresponding function, and includes EMAIL CSP, PROXY CSP, NAP (Network Access Point) CSP, and the like. In this case, the NAP CSP manages settings for network connection, and performs connection to networks using the network connection information stored in the electronic device.

For example, the processor 600 performs network connection using a RIL (Radio Interface Layer) 622.

Referring to FIG. 7, the processor (application processor) 630 includes a plurality of Configuration Service Providers (CSP) 640 and drivers 650. Also, the processor 630 may include an APN CSP 642. The APN CSP 642 manages an APN updated by a service provider, and the APN CSP 642 stores the updated APN in a nonvolatile area.

If a request of updating of the APN is received 632 through an NAP (e.g., an OMA DM command), the APN CSP 642 checks the updating request provided by the service provider and acquires APN information provided by the service provider.

Thereafter, the APN CSP 642 calls an API 652 for enabling the updated APN information to be stored, and, thereafter, stores the updated APN information in a nonvolatile area through the Radio Interface Layer (RIL). In this case, the nonvolatile area in which the updated APN information is stored may be the nonvolatile area of the memory. According to another exemplary embodiment, an area in which nonvolatile data, such as information about available frequency bands exists in the Communication Processor (CP), so that the updated APN information can be stored in the nonvolatile area 662 of the communication processor.

As described above, exemplary embodiments of the present invention back up network connection information used for network connection at the time when the network connection information is updated in an electronic device, so that connection to networks can be performed using the back up network connection information even through initialization has been performed.

It will be appreciated that exemplary embodiments of the present invention according to the claims and description in the specification can be realized in the form of hardware, software or a combination of hardware and software. Any such software may be stored in a non-transient computer readable storage medium. The non-transient computer readable storage medium stores one or more non-transit programs (software modules), the one or more programs comprising instructions, which when executed by one or more processors in an electronic device, cause the electronic device to perform a method according to exemplary embodiments of the present invention. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are exemplary embodiments of non-transient machine-readable storage that are suitable for storing a program or programs comprising instructions that, when executed, implement exemplary embodiments of the present invention. Accordingly, exemplary embodiments of the present invention provide a program comprising code for implementing apparatus or a method as claimed in any one of the claims of this specification and a non-transient machine-readable storage storing such a program. Still further, such programs may be conveyed electronically via any medium such as a communication signal carried over a wired or wireless connection and exemplary embodiments suitably encompass the same.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for managing network connection information in an electronic device, the method comprising:
when first network connection information stored in a memory upon performance of an initialization booting operation is different from second network connection information, using the second network connection information for network connection,
wherein the first network connection information corresponds to network connection information defined by default in the electronic device and the second network connection information corresponds to network connection information updated by a service provider.

2. The method of claim 1, further comprising:
when the first network connection information is updated before the initialization of the electronic device, generating the second network connection information by storing the updated network connection information in a non-volatile area of the memory.

3. The method of claim 1, further comprising:
when the electronic device is booted after the initialization, loading the first network connection information stored in the memory into an application processing unit;
when the second network connection information exists in the non-volatile area of the memory, replacing the first network connection information with the second network connection information; and
connecting to a network using the second connection information existing in the application processing unit.

4. The method of claim 3, further comprising:
when the second network connection information exists in the non-volatile area of the memory, connecting to a network using the first network connection information loaded into the application processing unit.

5. The method of claim 2, wherein the non-volatile area of the memory in which the second network connection information is stored includes a storage area of the processor.

6. The method of claim 1, wherein the network connection information includes at least one of an Access Point Name (APN), authentication information and a user name.

7. A device for managing network connection information in an electronic device, the device comprising:
at least one processor;
a memory; and
at least one module stored in the memory and configured to be executable by the processor,
wherein the module comprises an instruction for, when first network connection information stored in the memory upon performance of an initialization booting operation is different from second network connection information, using the second network connection information for network connection,
wherein the first network connection information corresponds to network connection information defined by default in the electronic device and the second network connection information corresponds to network connection information updated by a service provider.

8. The device of claim 1, the module comprises an instruction for:
when the first network connection information is updated before the initialization of the electronic device, generating the second network connection information by storing the updated network connection information in a non-volatile area of the memory.

9. The device of claim 7, the module comprises an instruction for:
when the electronic device is booted after the initialization, loading the first network connection information stored in the memory into an application processing unit;
when the second network connection information exists in the non-volatile area of the memory, replacing the first network connection information with the second network connection information; and
connecting to a network using the second connection information existing in the application processing unit.

10. The device of claim 9, the module comprises an instruction for:
when the second network connection information exists in the non-volatile area of the memory, connecting to a network using the first network connection information loaded into the application processing unit.

11. The device of claim 8, the module comprises an instruction for storing the second network connection information in the non-volatile area of the processor.

12. The device of claim 7, wherein the network connection information includes at least one of an Access Point Name (APN), authentication information, and a user name.

13. An electronic device capable of connecting to a network, the device comprising:
at least one processor;
a memory; and
at least one module stored in the memory and configured to be executable by the processor,
wherein the module comprises an instruction for:
when Access Point Name (APN) information is updated, storing the updated APN information in a non-volatile memory, and, when an initialization booting operation is performed, performing connection to a network using the updated APN information stored in the non-volatile memory.

14. The device of claim 13, wherein the module comprises an instruction for:
when the APN information is updated, updating the APN information in a first memory and backing up the updated APN information into a second memory which is a non-volatile memory, and, when the APN information of the first memory is different from the APN information of the second memory, using the APN information of the second memory for network connection.
